(19) United States
(12) Patent Application Publication
(10) Pub. No.: US 2024/0378238 A1
(43) Pub. Date: Nov. 14, 2024

(54) WIRELESS WEARABLE CONSTRUCTION SITE COMMUNICATION RECORDING AND GENERATIVE AL ANALYSIS SYSTEM WITH USER-CONTROLLED PRIVACY FEATURES

(71) Applicant: TerraScape AI, LLC, Rocklin, CA (US)

(72) Inventor: Medo Eldin, Rocklin, CA (US)

(73) Assignee: TerraScape AI, LLC, Rocklin, CA (US)

(21) Appl. No.: 18/656,822

(22) Filed: May 7, 2024

Related U.S. Application Data
(60) Provisional application No. 63/465,606, filed on May 11, 2023.

(51) Int. Cl. G06F 16/683; G06F 16/68

(52) U.S. Cl. CPC G06F 16/685; G06F 16/686

(57) ABSTRACT

A wireless wearable construction site communication recording and analysis system designed to capture and analyze conversations between construction workers, consultants, and vendors. The system utilizes advanced natural language processing and various generative artificial intelligence techniques to provide comprehensive insights into project status, challenges, and obstacles and includes a privacy timer function, which can be actively activated by users pressing a button, allowing them to temporarily deactivate the audio recording system for a specified period. The privacy timer deactivates passively once the duration has passed, providing audible notifications when recording resumes. The system employs low-cost, low-energy wireless communication methods, and a central hub for data transfer. A web-based dashboard allows project leaders to monitor and manage system settings and insights. Offering a solution for improving construction project management and efficiency, the disclosure provides project leaders with a more complete understanding of project status and potential obstacles.

### TECHNICAL FIELD

The present disclosure relates generally to the field of construction project management and communication. More specifically, the disclosure pertains to a wireless wearable system that passively records and analyzes conversations between construction site personnel using natural language processing and various generative artificial intelligence techniques.

### BACKGROUND

Industrial projects, particularly those involving complex manufacturing processes or large-scale infrastructure development, are often subject to numerous uncertainties and challenges that may lead to deviations from the original project plan. Such deviations can result in increased costs, delays, reduced quality, and other negative consequences for the industrial site. Early identification of potential deviations is crucial to mitigate their impact and minimize any resulting damage.

Traditional methods for identifying deviations include regular inspections, visual observations, and data analysis from various sources such as production reports, maintenance records, and quality control logs. However, these methods can be time-consuming, labor-intensive, and prone to errors or oversight. Furthermore, the vast amount of data generated in industrial settings requires advanced data processing and analytical tools to extract meaningful insights.

The present disclosure addresses these challenges by providing a system and method for identifying potential deviations from project plans at industrial sites using advanced audio processing techniques. This leverages the wealth of information contained in ambient sound recordings to monitor the ongoing industrial processes, enabling early detection and efficient resolution of issues that may impact project execution. By combining automation with human expertise, the proposed system offers a cost-effective, accurate, and scalable solution to optimize industrial operations and ensure adherence to project plans.

For example, in the construction industry, effective communication between workers, consultants, and vendors is crucial to the successful completion of projects. Construction projects often involve complex tasks, tight schedules, and multiple stakeholders, making clear communication and coordination essential. However, due to the dynamic and fast-paced nature of construction sites, important conversations and discussions may not always be accurately documented or conveyed to project leaders.

Existing solutions for construction communication and documentation, such as project management software, primarily rely on manual input from workers and consultants, which can be time-consuming, prone to errors, or incomplete. Additionally, these solutions may not capture the full context or nuances of conversations occurring at the construction site, leading to gaps in information and understanding.

Furthermore, traditional communication methods used in construction, such as walkie-talkies or phones, may be insufficient to address the challenges of noisy environments or the need for real-time information sharing and analysis. There is a need for an automated, comprehensive solution that can capture and analyze construction site communications, providing project leaders with valuable insights to facilitate better decision-making and coordination. Moreover, the solution should take into consideration the specific requirements of constriction sites, including the need for low-cost, low-energy, and long-range wireless data transfer methods, as well as a practical and efficient data transfer setup involving a central hub at the construction site. However, a significant concern associated with passive recording devices is the potential infringement on user privacy.

Therefore, in light of the foregoing discussion, there exists a need to overcome the aforementioned drawbacks associated with identifying issues at industrial site which may deviate from the project plan.

### SUMMARY

The aim of the present disclosure is to provide a solution on how to identify issues at industrial site which may deviate from the project plan. The aim of the disclosure is achieved by a method and data processing system for identifying deviations from planned activities at an industrial site and an audio recording device as defined in the appended independent claims to which reference is made to. Advantageous features are set out in the appended dependent claims.

To address this issue, the present disclosure proposes a privacy timer solution, which allows users to temporarily deactivate active recording for a specified period. The device notifies users when the recording is turned on or off, ensuring they are aware of the system's status and providing them with control over their privacy. This aims to alleviate privacy concerns and improve user acceptance of the technology.

The present disclosure seeks to address these challenges by providing a wireless wearable system designed to passively record and analyze conversations between construction site personnel, leveraging natural language processing and various generative artificial intelligence techniques, including topic modeling, sentiment analysis, keyword extraction, trend analysis, anomaly detection, automated summarization, and action item identification. The disclosure encompasses alternative embodiments for the wearable device, catering to various form factors, and attachment mechanisms. This system offers a novel solution for improving construction project management and efficiency by providing project leaders with a more complete understanding of project status and potential obstacles, while mitigating privacy concerns through the proposed privacy timer solution and addressing the data transfer requirements specific to construction sites.

The disclosure further addresses privacy concerns by incorporating a privacy timer solution, enabling users to temporarily deactivate audio recording while being notified of the system's status. This enhances construction project management and efficiency by providing project leaders with a comprehensive understanding of project status, potential obstacles, and facilitating better decision-making and coordination, all while ensuring user privacy.

The present disclosure is a wireless wearable construction site communication recording and analysis system designed to passively record and analyze conversations between construction workers, consultants, and vendors. The system consists of a durable, lightweight wearable device equipped with a high-quality microphone and noise reduction audio recording technology, and wireless connectivity utilizing low-cost, low-energy communication methods for real-time data transmission. A central hub is set up at the construction site, acting as a temporary storage and relay point for the audio data collected from the wearable devices before it is transmitted to a secure server for AI processing. To further address privacy concerns, the device includes an feature that allows users to temporarily deactivate audio recording for a specified period, providing control over when the recording is active. The disclosure also encompasses alternative embodiments for the wearable device.

The wearable device captures conversations on the construction site and transmits the recorded data via communication protocols to the central hub, which temporarily stores the data before sending it to a secure central server. The central server utilizes advanced natural language processing algorithms and various generative artificial intelligence techniques, including topic modeling, sentiment analysis, keyword extraction, trend analysis, anomaly detection, automated summarization, and action item identification, to analyze the recorded conversations and provide comprehensive insights into project status, challenges, and obstacles. The system offers construction leaders valuable information, enabling them to make informed decisions and coordinate workers and materials more effectively.

These embodiments aim to enhance usability, convenience, and adaptability, while ensuring optimal audio capture in diverse construction site environments and user preferences. The disclosure facilitates efficient decision-making, coordination, and communication among team members by integrating seamlessly with popular construction management software platforms.

Additional aspects, advantages, features and objects of the present disclosure would be made apparent from the drawings and the detailed description of the illustrative embodiments construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the embodiments of the disclosure are shown in the drawings, with references to the following diagrams wherein:

FIG. 1: A schematic view of the interior of the wearable device;

FIG. 2: The internal view of the wearable device;

FIG. 3: The exterior view of the wearable device;

FIG. 4: An alternative embodiment of the wearable device, showing the microphone unit integrated into a construction helmet with privacy timer button;

FIG. 5: A flowchart depicting the process of recording, transmitting, and analyzing construction site conversations using the wearable device, central hub, AI server, system server, and user web-based dashboard.

### DETAILED DESCRIPTION OF EMBODIMENTS

The following detailed description illustrates embodiments of the present disclosure and ways in which they can be implemented. In an aspect, the present disclosure provides a method and system for identifying deviations from planned activities at an industrial site.

The disclosed method for identifying deviations from planned activities at an industrial site comprises obtaining a reference data of the industrial site; predefining a time period for recording conversations occurring at the industrial site; recording one or more conversations occurring during the predefined time period by one or more audio recording devices; during the recording, implementing a privacy function upon detecting a privacy trigger; performing an analysis of the recorded one or more conversations against the reference data; identifying deviations from planned activities at the industrial site based on the analysed one or more conversations and the reference data.

The method aims to overcome the challenges of early and efficient identification of potential issues that may impact project execution at industrial sites. The method offers a cost-effective, accurate, and scalable solution to optimize industrial operations and ensure adherence to project plans. Early detection of potential problems allows for swift corrective actions, reducing the likelihood of costly delays or project downtime. The method provides a structured approach for monitoring and analyzing conversations, ensuring that all relevant information is captured and considered. By implementing privacy functions, the method enables to protect workers' rights while still providing valuable insights. The method thus enables teal-time monitoring of industrial site activities, identification of deviations from planned activities, proactive measures to prevent potential issues, improved project management decision-making through data-driven insights. The use of audio recording devices and privacy functions also ensures that confidential information is protected. Technical effects include improved efficiency, increased safety, and reduced downtime at the industrial site.

The industrial site may be a construction site, mining site, manufacturing facility, etc. The aim is to identify potential issues at the site to enable the project managers to implement preventive measures (e.g., to avoid project downtimes, and other costly problems).

The reference data is e.g., surveys related to the construction site and the environment; architectural drawings, engineering plans (including structural, mechanical, electrical, and plumbing plans); laws, regulations, permits; construction specifications (including information related to materials, amounts, delivery times, etc); budget estimations; work schedule; safety plan).

The one or more audio recording devices may be wearable audio recording devices, handheld digital recorders, field recorders, stationary recording devices, and others.

In an embodiment, wherein the audio recording device is wearable device, the wearable device is a compact, lightweight, and durable unit designed for use in construction site environments. It incorporates a high-quality microphone, noise reduction technology, wireless connectivity using low-cost, low-energy communication methods, and a rechargeable battery capable of powering the device for a standard workday (e.g., at least 8 hours) or some other time period according to the corresponding situation. The device is water and dust-resistant, ensuring it can withstand harsh conditions commonly encountered on construction sites.

The wearable device can be attached to a worker's collar or chest harness, allowing for comfortable and unobtrusive use while working. The attachment mechanism is designed to be secure yet easily adjustable, ensuring the device remains in place during physical activities but can be quickly removed or repositioned as needed.

The wearable device may comprise Noise Reduction and Audio Signal Activation means. The wearable device employs advanced noise reduction technology to isolate and capture clear audio of conversations in noisy construction environments. This may include beamforming techniques, which utilize multiple microphones to focus on a specific audio source, or digital signal processing algorithms that filter out background noise.

The wearable device may be a compact, durable, and ergonomic wearable device with a microphone, noise reduction technology, and wireless connectivity using low-cost, low-energy communication methods.

### Alternative Embodiments of the Wearable Device

In addition to the primary embodiment described above, the wearable device can be adapted to integrate with various construction site equipment or accessories, allowing for different user preferences or specific project requirements.
Integrated Microphone in Construction Helmet
Integrated Microphone in Construction Vest.
Necklace-style Wearable Device

These alternative embodiments of the wearable device aim to enhance the ease of use, convenience, and practicality of the system by offering various options for integrating the device into the construction worker's attire or equipment.

Alternative embodiments for the wearable device cater to various form factors and attachment mechanisms, focusing on the integration of the microphone in different passive states, such as integration within a construction helmet, a construction vest or harness, or a necklace-style accessory.

Alternative embodiments for the wearable device, catering to various form factors and attachment mechanisms.

Recording of verbal audio with associated time-stamps for conversation modeling.

Real-time or delayed data transmission to a secure central server for analysis and storage using cellular or WIFI communication protocols.

Advanced natural language processing and various generative AI-powered analytics techniques to generate actionable insights.

Compliance with privacy and workplace surveillance regulations.

In an example, the audio recording device is configured to work also as Wireless connectivity module: A module supporting low-cost, low-energy communication methods for real-time data transmission. In the example the audio recording device comprising a microphone, a battery, processor and memory, a privacy timer button, an indicator or a display, a speaker or an audio output, an attachment mechanism and enclosure

Microphone: A high-quality microphone for capturing conversations and ambient sounds on the construction site. The microphone array may comprise an integrated background noise filtering means for a use at the industrial sites.

Battery: A rechargeable and replaceable battery to power the device with a plug-in charging port, designed for long-lasting operation.

Processor and memory: A microprocessor and memory for handling basic operations, buffering audio, and managing wireless communication.

Privacy timer button: A physical button for activating the user-controlled privacy timer, which temporarily deactivates active recording.

Indicator lights or display: Indicator lights or a small display to show device status, including battery level, connectivity, and recording status.

Speaker or audio output: A speaker or audio output for audible notifications related to the privacy timer and device status.

Attachment mechanism: A clip, strap, or other attachment mechanism for securing the wearable device to clothing, hard hats, or other equipment.

Enclosure: A durable and ergonomic enclosure designed to protect the device's components from the harsh construction site environment and withstand impact, dust, and water exposure.

### Examples of Usage Methods

Workers can easily start using the wearable device by attaching it to their hard hat, collar, or chest harness and connecting it to the wireless network. The audio recording system will automatically begin capturing relevant conversations, transmitting the data to the central hub and then to the central server for analysis. Project leaders can access the analyzed data and insights through the web-based dashboard or their construction management software, using the information to make informed decisions about resource allocation, problem-solving, and project planning.

Gathering all relevant information related to the industrial site, including surveys, architectural drawings, engineering plans, laws and regulations, permits, construction specifications, budget estimations, and work schedules provides a baseline against which deviations from planned activities can be identified. Obtaining the reference data is crucial for establishing a baseline against which recorded conversations can be analyzed to identify deviations. This allows the system to learn normal operating conditions, making it more effective in detecting anomalies and deviations from planned activities. It provides better understanding of normal operations leads to more accurate issue detection.

By predefining the time period for recording conversations and setting a specific time period for recording conversations, the system can focus on analyzing data related to relevant periods, minimizing noise and redundant information. The predefined time period may be working day or a certain length of time period in hours. This helps to improve analysis efficiency and accuracy and targeted analysis of relevant data leads to faster issue identification. By setting the predefined time period for recording conversations at the industrial site, the system can ensure that all relevant discussions taking place during this time are captured and analyzed. This is important for accurately identifying deviations from planned activities. Determining a specific timeframe for recording conversations at the industrial site allows for focused data collection and analysis.

Recording and analyzing the conversations allows to capture valuable information about ongoing processes at the industrial site, enabling automatic detection of potential issues. The use of audio recording devices allows for the capture of conversations in real-time, enabling the system to identify potential issues as they arise. The privacy function implemented during recording ensures that confidential information is protected.

By implementing the privacy function, the system can automatically or manually switch off recording in sensitive areas or during private conversations. Introducing measures to protect individuals' privacy when necessary, such as automatically muting or redacting sensitive information, ensures that the collected data is both useful and respectful. Implementing the privacy function upon detecting the privacy trigger helps ensure that privacy is respected by automatically disabling recording when the privacy trigger is detected.

Comparing the recorded conversations with the pre-existing reference data enables to identify any discrepancies or deviations from planned activities. The analysis involves comparing the recorded conversations against the reference data to identify any deviations from planned activities. For example, if a conversation indicates that a delivery date has been changed or that a safety regulation has been violated, this would be considered a deviation.

Using the results of the analysis, the method detects potential issues that may deviate from the project plan, enabling proactive measures to be taken by project managers. Using the information gathered from the analysis to identify specific deviations from planned activities enables to alert project managers so that preventative measures can be taken.

By comparing analyzed conversations against the reference data, the system can pinpoint any deviations from planned activities. This may trigger further investigation or automated responses as necessary, leading to proactive resolution of issues, which enables quick issue identification and timely intervention and minimize negative consequences for the industrial site.

In the embodiments of the present disclosure, obtaining the reference data comprises at least one of: using a predefined template to generate the reference data; obtaining the reference data through integration with one or more existing systems; obtaining the reference data by leveraging machine learning algorithms; using natural language processing techniques to analyze and extract relevant information from existing documents; or utilizing computer vision techniques to capture and process visual data related to the industrial site. Advantages of these embodiments of obtaining the reference data comprise reduced time and resources required for data collection and analysis, increased accuracy and efficiency, and improved flexibility in obtaining reference data from various sources. Such reference data gathering techniques provide improved data processing speed, increased accuracy in identifying deviations, and reduced reliance on manual methods for data analysis.

Using the predefined template to populate the reference data provides a structured way of collecting and organizing the reference data, which might not have been done before. This involves creating a standardized template that can be used to generate the reference data. The template would include fields for all relevant information related to the industrial site, such as surveys, architectural drawings, engineering plans, laws and regulations, permits, construction specifications, budget estimations, and work schedules. By using the predefined template, the system can ensure that all necessary information is collected and organized in a consistent manner, making it easier to analyze for deviations from planned activities. This helps lead to improved accuracy, efficiency, or consistency in the data collection process.

Integrating with existing systems (such as construction management software or building information modeling (BIM) tools) enables seamless communication between different software applications or tools, which might not have been possible previously. This integration provides a more comprehensive and streamlined solution for collecting and analyzing reference data. Integration of the system with existing system may also comprise integration with existing databases or software applications that contain the required reference data. E.g., the system may be integrated with a construction management software application that stores all relevant project information. By leveraging existing systems, the method can reduce the time and resources required to gather and input reference data manually.

Obtaining the reference data by leveraging machine learning algorithms may comprise using machine learning algorithms to automatically extract and identify relevant information from unstructured data sources, such as emails, reports, or other documents. The system may be trained on a large dataset of labeled reference data to recognize patterns and extract key information related to the industrial site and planned activities. By using machine learning algorithms, the method can quickly and accurately process large amounts of data, reducing the need for manual data entry and analysis.

Using natural language processing techniques to analyze and extract relevant information from existing documents comprises using natural language processing (NLP) techniques to extract relevant information from text-based documents, such as reports, emails, or contracts. NLP algorithms can be used to identify keywords and phrases related to the industrial site and planned activities, making it easier to identify deviations. By using NLP techniques, the method can process large amounts of data more efficiently, reducing the time and resources required for analysis.

Utilizing computer vision techniques to capture and process visual data related to the industrial site comprises using computer vision techniques to analyze visual data, such as photographs or video footage, to identify deviations from planned activities at the industrial site. E.g., the system may be trained to recognize specific construction equipment or materials, allowing it to detect when they are not present or being used in the expected location. By using computer vision techniques, the method can quickly and accurately process visual data, reducing the need for manual inspections and increasing efficiency.

In the embodiments of the present disclosure predefining the time period for recording conversations occurring at the industrial site comprises at least one of: using a schedule of planned activities; using machine learning algorithms to predict and adjust the time period based on historical data; setting different time periods for different areas of the industrial site; or by integrating with existing scheduling or project management tools.

Predefining the time period for recording conversations occurring at the industrial site provides increased accuracy in identifying potential issues by capturing conversations during critical periods, reduced need for manual intervention, and improved flexibility in setting recording periods based on specific project requirements, which enable to improve data processing speed, increase accuracy in identifying deviations, and reduce reliance on manual methods for scheduling recording periods.

Using the schedule of planned activities comprises setting the time period for recording conversations based on a predefined schedule of planned activities. E.g., the system may be configured to start recording conversations during the construction phase of a project and stop recording once the project is completed. By using a schedule of planned activities, the method ensures that all relevant conversations are captured and analyzed without the need for manual intervention.

Using machine learning algorithms to predict and adjust the time period based on historical data comprises using machine learning algorithms to predict when deviations from planned activities are most likely to occur based on historical data. The system may be configured to analyze past projects and identify patterns in when issues arose, allowing it to automatically adjust the recording time period to capture conversations during these critical periods. By using machine learning algorithms, the method improves its accuracy in identifying potential issues and reduce the need for manual intervention.

Setting different time periods for different areas of the industrial site comprises setting different time periods for recording conversations in different areas of the industrial site. For example, high-risk areas or areas with a history of frequent deviations may have longer recording periods to ensure that all relevant conversations are captured. By setting different time periods for different areas, the method increases its accuracy in identifying potential issues and provides more detailed information to project managers.

By integrating with existing scheduling or project management tools comprises integrating the system with existing scheduling or project management tools to automatically set the time period for recording conversations based on the project schedule. For example, the system may be integrated with a construction management software application that provides real-time updates on the project schedule. By integrating with these tools, the method reduces the need for manual data entry and ensure that all recording periods are accurately synchronized with the project schedule.

In the embodiments of the present disclosure implementing the privacy function comprises at least one of: using a manual on/off function in the audio recording device; using an automatic on/off function; providing a standalone device at private zones configured to switch off all audio recording devices in range; automatically switching another audio recording device into privacy mode if nearby a first audio recording device is already in privacy mode; using a user-controllable privacy timer functionality on the audio recording device to temporarily deactivate recording; or limiting the number of privacy sessions per predefined period and/or restricting privacy sessions to specific times according to a schedule. Implementing the privacy function enables to increase protection of confidential information, reduced potential for accidental recording of sensitive discussions, and improved user control over privacy settings. This improve data security, reduces risk of legal disputes, and increases trust from workers and stakeholders in the recording system. The privacy function is important to ensure that confidential information is protected, especially in industrial sites where sensitive discussions may take place.

Using a manual on/off function in the audio recording device allows users to manually turn on or off the privacy function on the audio recording device. For example, project managers or workers may activate the privacy function when discussing confidential information, such as safety concerns or financial details. By providing a manual control, the method ensures that privacy is respected and confidential information is protected.

Using an automatic on/off function comprises using sensors or other automated methods to detect when a privacy trigger has been activated and automatically switch the recording device into privacy mode. For example, the system may be configured to activate the privacy function when it detects a specific keyword or phrase. By using automatic on/off functions, the method can ensure that recordings are stopped promptly when sensitive discussions take place, protecting confidential information.

Providing a standalone device at private zones configured to switch off all audio recording devices in range comprises providing a standalone device that can be used to disable all nearby audio recording devices when privacy is required. For example, project managers or workers could carry a remote control device that can deactivate all audio recording devices within a certain radius. Or, according to another example the private zone may be toilet, bathrooms, etc., and the standalone device is configured to switch off all the audio recording devices when the users are entering into corresponding private zone.

By using the standalone device, the method ensures that privacy is respected in designated private zones and prevents accidental recordings of sensitive discussions.

Automatically switching another audio recording device into privacy mode if nearby a first audio recording device is already in privacy mode comprises using sensors or other automated methods to detect when two recording devices are close enough to each other for one to potentially pick up the conversation of the other, and automatically activating the privacy function on both devices. By using this approach, the method prevents accidental recordings of sensitive discussions that could occur if multiple recording devices are in use in close proximity.

Using a user-controllable privacy timer functionality on the audio recording device to temporarily deactivate recording allows users to manually disable the recording function for a predefined period using a built-in timer on the audio recording device. For example, workers may use this feature to take breaks or engage in personal conversations without fear of being recorded. By providing the user-controllable privacy timer, the method ensures that privacy is respected and that recordings are only made when necessary for identifying issues at the industrial site.

Limiting the number of privacy sessions per predefined period and/or restricting privacy sessions to specific times according to a schedule (e.g., lunch time) comprises placing restrictions on the use of the privacy function, such as limiting the number of privacy sessions per day or week, or restricting their use to certain hours of the day. By using these restrictions, the method ensures that the privacy function is used appropriately and that recordings are made only when necessary for identifying issues at the industrial site while respecting privacy concerns.

Such Privacy Timer and User Control means enables to further mitigate privacy concerns, the device incorporates a privacy timer function that allows users to temporarily deactivate audio recording for a specified period, such as 15 or 20 minutes. When the device is turned on, it notifies the wearer that audio recording is active. If the user desires privacy at any point during the day, they can press a button or voice authenticated disablement to disable the recording system for the specified time interval. At the end of this period, the device audibly notifies the user that active recording has resumed. Users can extend the privacy period by pressing the button again, with the total duration and number of consecutive privacy activations being customizable by the owner or project leader.

The user-controlled privacy timer may be activated by the push of a button on the wearable device or by voice authenticated disablement, allowing temporary deactivation of audio recording.

Upon the end of the designated privacy period, the user is notified that active recording has been reactivated, ensuring they are aware of the system's status. The feature includes audible notifications for status updates and customizable settings for privacy duration and activation frequency, addressing privacy concerns.

According to the embodiments of the present disclosure, detecting the privacy trigger comprises at least one of using audio signal processing techniques to identify keywords indicating a requirement of privacy; analyzing environmental factors; identifying another audio recording device in privacy mode nearby; integrating with other devices to gather additional data for detecting privacy triggers; determining if the standalone device at the private zone is present and active; detecting the scheduled time for restricted privacy sessions; or receiving user input to initiate the detection of the privacy trigger.

The privacy trigger is an important aspect of ensuring that confidential information is protected, especially in industrial sites where sensitive discussions may take place. Detecting the privacy trigger enables to increase protection of confidential information, reduce potential for accidental recording of sensitive discussions, and improve user control over privacy settings. This improves data security, reduces risk of legal disputes, and increase trust from workers and stakeholders in the recording system.

Using audio signal processing techniques to identify keywords indicating a requirement of privacy comprises using audio signal processing algorithms to analyze conversations and identify keywords or phrases that indicate a requirement for privacy, such as “confidential,” “privileged information,” or “do not record.” By using audio signal processing techniques, the method enables automatically to detect and respond to privacy triggers without the need for manual intervention.

Analyzing environmental factors comprises analyzing environmental conditions, such as noise levels, ambient light, temperature, or humidity, to determine if a privacy trigger has been activated. For example, if the ambient noise level in an area increases suddenly, indicating a potentially sensitive conversation, the method may automatically activate the privacy function. By using environmental analysis, the method can detect and respond to privacy triggers even when no specific keywords are present.

Identifying another audio recording device in privacy mode nearby comprises using sensors or other methods to detect the presence of another audio recording device in the vicinity that is already in privacy mode. By detecting the presence of multiple privacy-enabled devices, the method can automatically activate the privacy function on all nearby recording devices to prevent accidental recordings of sensitive discussions.

Integrating with other devices (such as cameras or motion detectors) to gather additional data for detecting privacy triggers comprises integrating the audio recording system with other devices or systems to gather additional data that can be used to detect privacy triggers. For example, the method may integrate with a calendar application to detect scheduled meetings or appointments, or with an access control system to determine if a particular area is restricted. By using integrated data sources, the method can more accurately and effectively detect privacy triggers.

Determining if the standalone device at the private zone is present and active comprises using sensors or other methods to detect the presence and activity of a standalone device that has been configured as a privacy trigger. For example, if a worker enters a designated private zone carrying the standalone device, the method may automatically activate the privacy function on all recording devices in the area. By using a dedicated privacy trigger device, the method can provide an easy-to-use and effective way for workers to request privacy.

Detecting the scheduled time for restricted privacy sessions comprises integrating with scheduling or project management tools to detect when restricted privacy sessions have been scheduled. For example, if a meeting has been scheduled as confidential, the method can automatically activate the privacy function on all recording devices in the area during the scheduled session. By using scheduled privacy sessions, the method can ensure that privacy is respected and that recordings are only made when necessary for identifying issues at the industrial site while respecting privacy concerns.

Receiving user input (such as button presses or voice commands) to initiate the detection of the privacy trigger comprises allowing users to manually initiate the privacy function by providing a user interface or other means of input, such as a button press or voice command. By allowing users to manually initiate privacy sessions, the method can provide greater flexibility and control over privacy settings.

According to the embodiments, preforming the analysis of the recorded one or more conversations against the reference data comprises one or more artificial intelligence techniques selected from a group comprising topic modeling, sentiment analysis, keyword extraction, trend analysis, anomaly detection, automated summarization, or action item identification. Corresponding one or more AI models may run in the system server (remote or cloud) or in a separate AI server. The use of AI techniques is important for effectively processing large amounts of data and identifying potential issues at industrial sites that may deviate from project plans. Employing advanced artificial intelligence techniques allows for automated identification of deviations from planned activities based on the analyzed conversations and reference data. This enables faster issue identification and reduced reliance on manual intervention. These AI techniques enable to increase efficiency in processing large amounts of data, improve accuracy in identifying potential issues, and reduce manual effort required for data analysis. The use of these AI techniques further improves safety and productivity at industrial sites by enabling prompt identification and resolution of issues, as well as better communication and collaboration among team members.

Generative AI Techniques and Benefits. The generative AI software utilized in the system is capable of employing various techniques to process the recorded input data, providing valuable insights and facilitating construction management and coordination. These techniques include following.

Topic Modeling: The AI can analyze the conversations to identify common topics and themes discussed among workers, consultants, and vendors. This can help project leaders understand the most pressing concerns and prioritize their efforts accordingly. This technique involves analyzing the recorded conversations to identify topics or themes that are being discussed. By using topic modeling, the method can quickly and accurately identify conversations that relate to specific issues, such as safety concerns, equipment failures, or project delays. This information can then be used to prioritize follow-up actions and address potential issues before they become more serious.

Sentiment Analysis: By examining the tone and sentiment of the conversations, the AI can identify potential conflicts or dissatisfaction among team members, enabling project leaders to address issues proactively and maintain a positive work environment. This technique involves analyzing the emotional tone of recorded conversations to determine if they are positive, negative, or neutral. By using sentiment analysis, the method can identify conversations that express concern, frustration, or dissatisfaction, indicating potential issues that may require further investigation. Additionally, sentiment analysis can be used to monitor employee morale and address any negative emotions that could impact productivity or safety.

Keyword Extraction: The AI can extract specific keywords and phrases from the conversations, allowing project leaders to quickly identify critical information, such as safety concerns, schedule delays, or material shortages, and take corrective actions in a timely manner. This technique involves identifying and extracting specific keywords from recorded conversations that are relevant to the industrial site and project plan. By using keyword extraction, the method can quickly identify conversations that discuss potential issues, such as equipment failures, project delays, or safety concerns, allowing for prompt follow-up actions.

Trend Analysis: The AI can identify patterns and trends in the conversations over time, providing insights into recurring issues or emerging challenges. This can help project leaders anticipate potential problems and implement preventive measures. This technique involves analyzing historical data from recorded conversations to identify trends and patterns that may indicate potential issues at the industrial site. For example, if there is a trend of increasing numbers of conversations related to equipment failures, this could indicate a larger problem with equipment reliability that requires attention. By using trend analysis, the method can provide early warning of potential issues and enable preventive measures to be taken.

Anomaly Detection: The AI can detect unusual or unexpected conversations that deviate from typical patterns, alerting project leaders to potential issues that may warrant further investigation. This technique involves identifying unusual or unexpected patterns in recorded conversations that may indicate potential issues at the industrial site. For example, if a particular conversation deviates significantly from previous conversations on the same topic, this could indicate a new issue or a change in circumstances that requires further investigation. By using anomaly detection, the method can quickly identify potential issues and provide early warning to project managers.

Automated Summarization: The AI can generate concise summaries of the conversations, enabling project leaders to quickly review the information and make informed decisions without having to listen to hours of audio recordings. This technique involves automatically generating summaries of recorded conversations to provide an overview of the content without the need for manual review. By using automated summarization, the method can quickly process large amounts of data and identify potential issues that may require further investigation. Additionally, summaries can be used to keep project managers informed of ongoing activities and progress.

Action Item Identification: The AI can recognize action items or tasks mentioned in the conversations and automatically create a list of items for project leaders to follow up on, ensuring that nothing falls through the cracks. This technique involves automatically identifying specific actions that need to be taken based on the content of recorded conversations. For example, if a conversation discusses a safety concern, the method could automatically generate an action item to investigate the issue further and assign it to the appropriate team member. By using action item identification, the method can streamline workflows and enable prompt response to potential issues.

By incorporating these generative AI techniques, the system can analyze recorded conversations to provide valuable insights, enabling more effective construction management and coordination. The benefits of these techniques include improved decision-making, proactive issue resolution, efficient communication, and better overall project outcomes.

According to the embodiments, the method may further comprise identifying which recording belongs to which worker. Identifying which audio recording belongs to which worker enables more accurate analysis and reporting of conversations, facilitates easier tracking of individual worker performance and productivity, allows for more targeted training and coaching of workers. In the industrial site where multiple workers are speaking simultaneously, identifying which audio recording belongs to which worker enables better understanding of communication patterns and workflows. In a manufacturing facility where workers are performing different tasks, identifying which audio recording belongs to which worker allows for more accurate tracking of production line efficiency. Thus, identifying which recording belongs to which worker is important for accurately analyzing recorded conversations against reference data and identifying potential issues at industrial sites that may deviate from project plans.

Identifying which recording belongs to which worker may further comprise merging recording sessions using semantics, content, worker speaking manner, and tone. In this embodiment, an AI model is used to merge recording sessions together based on semantic and content similarity, as well as the speaking manner and tone of each worker. By merging sessions that belong to the same worker, the method can more accurately analyze conversations between workers and identify potential issues. This information can then be used to provide feedback to individual workers or teams, improving communication and productivity at the industrial site.

Identifying which recording belongs to which worker may additionally or alternatively further comprise recording the worker's identifier the worker is saying out loud (the worker's identifier may be a worker's name, code, etc.) in the beginning of each predefined period. Recording worker's identifier at the beginning of each predefined period requires each worker to record their identifier (such as a name or code) at the beginning of each predefined recording period. This information is then used to associate conversations with the correct worker, allowing for more accurate analysis and identification of potential issues. By requiring workers to record their identifiers, the method improves data accuracy and ensure that feedback and corrective actions are targeted to the appropriate individuals or teams.

Identifying which audio recording belongs to which worker enables to improve accuracy in identifying issues and assigning responsibility, increase efficiency in analyzing large amounts of recorded data, include better communication and collaboration among team members, reduce time spent on manual data processing, and more effectively identification potential issues at industrial sites.

According to the embodiments, the method further comprises transferring the recorded conversations from the audio recording device directly a server; to a central hub located at the industrial site and then from the central hub to the server; or downloading the recorded conversations to a temporary storage device and then uploading recorded conversations from the temporary storage device to a server. The recorded conversations from audio recording devices are transferred to the server for further analysis. To ensure data security the data transmission may be encrypted.

When transferring recorded conversations directly to the server, the audio recording devices are configured to transfer recorded conversations directly to the server (either remotely or locally) for storage and analysis. By eliminating the need for intermediate steps, such as downloading recorded conversations to a temporary storage device or using a central hub for data transfer, the data transfer efficiency is improved and latency in analysis reduced. This enables real-time or near real-time analysis of recorded conversations and identifying potential issues at industrial sites that may deviate from project plans.

### Example of Central Server and Data Analysis

The central server infrastructure receives, processes, and stores the recorded data from the wearable devices. It employs advanced natural language processing algorithms and generative artificial intelligence to analyze the conversations, identifying potential issues, challenges, and obstacles related to the construction project. The server infrastructure is designed to be secure, ensuring that the data is protected from unauthorized access and tampering.

When transferring recorded conversations to a central hub located at the industrial site and then to the server, the audio recording devices are configured to send recorded conversations to a central hub located at the industrial site, which then forwards the data to a server for storage and analysis. This is useful in situations where there is limited network connectivity between individual recording devices and the server, as the central hub can act as a relay point to facilitate data transfer.

In an embodiment, wherein the audio recording device is wearable device, the wearable device enables wireless connectivity and data transmission to the Central Hub and the wearable device is equipped with low-energy wireless connectivity modules that enable real-time data transmission to a central hub located at the construction site. This allows for continuous offloading of recorded data, reducing the need for large onboard storage capacity and ensuring that the data is readily available for analysis.

The central hub is a temporary storage and relay point for the audio data collected from the wearable devices. It receives the audio data from the devices and then transmits it to a secure central server for AI processing.

In an example, the central hub may be at the construction site, equipped with a hard drive, to receive, temporarily store, and relay the audio data from the wearable devices to a secure server for AI processing.

When downloading recorded conversations to a temporary storage device and uploading recorded conversations from the temporary storage device to a server, the audio recording devices store recorded conversations on a temporary storage device, which is then removed and connected to a computer or server for data transfer. This is useful in situations where there is limited network connectivity between individual recording devices and the server (e.g., underground), or when large amounts of data need to be transferred at once.

Optionally, the method may further comprise timestamping the recorded conversations with a first time stamp indicating the start of each sub-session of the conversation and a second time stamp indicating the end of each sub-session of the conversations. Timestamping recorded conversations with both a start time stamp and an end time stamp for each sub-session of a conversation in the method is important for accurately analyzing recorded conversations against reference data and identifying potential issues at industrial sites that may deviate from project plans, as well as providing context to specific parts of the conversation.

For example, the beginning and the end of the speech of a worker is time stamped: first time stamp (start of the speech), second time stamp (end of the speech) of a sub-session (the sub-session is when the worker says something); when the worker starts talking again, the beginning and the end of the speech is time stamped again and so on each time, when the worker re-starts talking.

The start and end time stamps help to break down long conversations into smaller sub-sessions, allowing for more granular analysis and identification of issues. For example, a single conversation between two workers might cover multiple topics or issues over an extended period of time. By timestamping each sub-session, it becomes easier to isolate specific parts of the conversation that are relevant to particular issues or topics, improving the accuracy and efficiency of data analysis.

Additionally, having precise time stamps is useful in identifying trends or patterns in conversations over time, such as an increase in discussions related to a particular issue or topic during certain hours of the day or days of the week. This information can then be used to inform targeted interventions or corrective actions to address potential issues before they become more serious.

Advantages of timestamping recorded conversations include improved accuracy and efficiency in data analysis, as well as increased insight into trends and patterns in industrial site communications. This enable better identification and resolution of potential issues at the industrial site through more precise analysis of recorded data, as well as increased transparency and accountability for workers and teams.

Optionally, the method may further comprise creating a data layer per the predefined time period comprising a data component and a time component. The data component may comprise reference data and recordings of the conversations, i.e., the audio data. Creating the data layer per predefined time period that consists of both the data component and the time component allows for more efficient and organized storage and analysis of large amounts of recorded conversations and reference data over extended periods of time, enabling effective identification of issues at industrial sites that may deviate from project plans.

The data layer serves as a container for all data related to a particular time period, making it easier to retrieve and analyze specific data when needed. The use of the separate data layer for each time period also simplifies the process of updating and managing reference data, ensuring that all data is up-to-date and relevant to ongoing analysis.

The advantages of creating the data layer per predefined time period is that it improves data organization and accessibility, reduces latency in data retrieval and analysis, and increases efficiency in managing large amounts of recorded conversations and reference data over extended periods of time. This enables more effective identification and resolution of potential issues at the industrial site through efficient analysis of relevant data, as well as easier compliance with data retention requirements and improved data security by allowing for granular access control to specific data layers.

The disclosed data processing system for identifying deviations from planned activities at an industrial site comprises one or more servers comprising an audio data processing unit, wherein the one or more servers are integrable with a management software platform; one or more audio recording devices wirelessly connected to the audio data processing unit; one or more user devices configured to run a user interface.

The data processing system enables users at industrial sites, such as construction sites, emergency services, manufacturing floors, outdoor events, mining sites, oil rigs, or transportation hubs, to capture and analyze conversations more effectively, providing valuable insights into project status and potential obstacles. The system may further comprise one or more of a central hub, a hard drive for temporary data storage, one or more wireless connectivity modules for securely receiving and relaying audio data from multiple wearable devices.

The data processing system for identifying deviations from planned activities at an industrial site enables efficiently to process audio data from recording devices, analyze conversations against reference data, and provide user interfaces for monitoring and analysis.

The one or more servers of the data processing system comprise an audio data processing unit, which is configured to be responsible for receiving, processing, and storing audio data from the recording devices. The integration with a management software platform allows for remote access to system functionality, data visualization, and analysis tools.

### Example of Integration with Construction Management Software

The system is designed to integrate seamlessly with popular construction management software platforms, enabling project leaders to access the insights and data generated by the system within their existing project management environment. This facilitates efficient decision-making, coordination, and communication among team members. Integration with popular construction management software for seamless data sharing and reporting.

The one or more audio recording devices are wirelessly connected to the audio data processing unit, allowing for real-time or near real-time transfer of recorded conversations for analysis. This wireless connectivity ensures that recorded data is readily available for processing and analysis as soon as it is captured.

The one or more user devices configured to run a user interface enable users to access system functionality and monitor data in real-time, providing valuable insights into potential issues at the industrial site. The use of user interfaces simplifies the process of analyzing data, identifying trends or patterns, and taking corrective actions when needed.

The advantages of the data processing system comprise improved efficiency and accuracy in identifying deviations from planned activities through of recorded conversations, increased scalability as additional recording devices can be added to the system, and improved flexibility with wireless connectivity for remote access to system functionality and data. This enables more effective identification and resolution of potential issues at the industrial site, improved communication and collaboration between teams through monitoring of conversations, and increased transparency and accountability for workers through recording and analysis of their communications.

In another aspect, an embodiment of the present disclosure provides an audio recording device for use in a method according to any of the embodiments of the present disclosure, wherein the audio recording device comprises a microphone array; a processor and memory module configured to control an operation of the audio recording device, run one or more software modules, buffer audio, and manage wireless communication; a wireless connectivity module; a privacy timer activation means; and a battery.

The microphone array is arranged to capture high-quality audio data from the industrial site environment. This ensures accurate recording of conversations and ambient sounds that can be analyzed for identifying potential issues.

The processor and memory module is configured to control the operation of the audio recording device, run one or more software modules for buffering and managing audio data, and manage wireless communication with the server. This processing power enables real-time or near real-time analysis of captured audio data against reference data, improving the speed and accuracy of issue identification.

The wireless connectivity module allows for seamless transfer of recorded audio data to the server for further analysis, ensuring that data is available for analysis as soon as it is captured. This wireless connectivity also enables remote access to system functionality and real-time monitoring of conversations from user interfaces.

The privacy timer activation means provides users with control over when recording is active, ensuring compliance with privacy regulations and protecting sensitive information. The use of a privacy timer also improves data security by reducing the amount of unnecessary data that needs to be transferred and stored.

The privacy timer activation means may be a mechanism or method for controlling when the audio recording function of the device is active, e.g., manual activation, automatic activation based on user presence, automatic activation based on predefined schedules, automatic activation based on audio triggers, or remote activation through management software platform.

In an example, wherein the privacy timer activation means is a mechanism, the user can manually turn on and off the recording function using a button or touch interface on the audio recording device. This gives users complete control over when their conversations are being recorded and ensures that their privacy is respected at all times.

In an example, wherein the privacy timer activation means is a method, wherein the privacy timer activation means can be automatically activated based on user presence, the audio recording device may be configured to automatically start recording when it detects the presence of a specific user (through a wearable ID or other means) and stop recording when they leave the area. This can help to ensure that conversations are only recorded when necessary, while still providing real-time analysis capabilities for issue identification.

In an example, wherein the privacy timer activation means is a method, wherein the privacy timer activation means can be automatically activated based on predefined schedules, the device may be programmed to automatically start and stop recording at specific times of the day or week (e.g., during work hours). This can help ensure that recordings are only taken when it is appropriate and necessary, while still providing comprehensive coverage for issue identification.

In an example, wherein the privacy timer activation means is a method, wherein the privacy timer activation means can be automatically activated based on audio triggers, the device may be configured to start recording when it detects certain audio triggers, such as specific keywords or phrases being spoken in the environment. This can help ensure that important conversations related to potential issues are always captured and analyzed, while still respecting user privacy by only recording when necessary.

In an example, wherein the privacy timer activation means is a method, wherein the privacy timer activation means can be automatically activated through a remote management software platform, the device may be remotely activated or deactivated through a management software platform, allowing administrators to control recording functionality centrally and ensure compliance with privacy regulations or company policies. This can help ensure that recordings are taken only when authorized and appropriate, while still providing comprehensive coverage for issue identification.

The audio recording device enables improved efficiency and accuracy in identifying issues at industrial sites through real-time or near real-time analysis of recorded conversations, increased scalability as additional devices can be easily integrated into the system, and improved privacy and security features with the use of a privacy timer. This enables more effective identification and resolution of potential issues at the industrial site, improved communication and collaboration between teams through real-time monitoring of conversations, and increased transparency and accountability for workers through recording and analysis of their communications.

Optionally, the microphone array of the audio recording device may comprise one or more multiple directional microphones configured to focus on specific audio sources, allowing for better separation and capture of desired sounds in noisy industrial environments. This improves the accuracy of recorded conversations and reduces the amount of background noise that needs to be processed during analysis.

The one or more software modules may comprise digital signal processing algorithms for noise reduction and speech enhancement, further improving the quality of captured audio data by eliminating unwanted noise and enhancing spoken words. This helps to lead to increased accuracy in identifying issues at the industrial site through clearer recordings, as well as improved user experience with more intelligible speech output from the system.

The audio recording device may comprise a user interface or proximity-based synchronization means (in case if two or more people each wearing the wearable audio recording device). The user interface can enable users to easily configure settings for their devices, view real-time data, and receive notifications of potential issues. Proximity-based synchronization means allows for seamless synchronization between multiple recording devices when they are in close proximity to each other, ensuring that conversations involving multiple people are accurately captured and analyzed as a single sub-session.

These additional optional features enable improved accuracy and reliability in identifying issues at industrial sites through clearer recordings, reduced processing time for large amounts of data due to noise reduction and speech enhancement algorithms, and increased flexibility and ease-of-use with the addition of user interfaces and proximity-based synchronization means. This enables better separation and capture of desired sounds in noisy environments, improved quality of recorded conversations, and more seamless collaboration between teams through accurate recording and analysis of multi-person conversations.

In an example, the audio recording device may be a wireless wearable device for construction site communication recording and analysis system, designed to capture and analyze conversations between construction workers, consultants, and vendors. The present detailed description provides an in-depth explanation of the components, functionality, and methods involved in using the audio recording device.

In another example the wearable audio recording device comprising a microphone, a speaker, an indicator light bulb, a privacy timer button pad, a processor and memory unit, a wireless connectivity module, a battery, an enclosure, a microphone opening, a speaker grill, an indicator light bulb, a privacy timer button, a battery access cover, and a clip on the device for attaching the wearable device to clothing or other objects. The microphone, an audio input component for capturing sounds in the surrounding environment is connected to the internal electronic system of the wearable device. The speaker, an audio output device for producing sound audible by humans, is integrated into the speaker grille of the enclosure. The speaker communicates with the processing unit through a similar connection as the microphone. The indicator light bulb, e.g., a light emitting diode (LED), that serves as a notification light or provide visual feedback to users, is connected to the device's processor and memory unit through a digital I/O pin on the microcontroller, allowing for control over its lighting state. The privacy timer button pad, e.g., a set of physical buttons enabling users to set a time duration of the privacy time period. The processor and memory unit, is the internal electronic component and responsible for executing instructions and storing data in the wearable device. The processor and memory unit integrates various functional blocks. The wireless connectivity module is a module designed to establish wireless connections between the wearable device and other devices or networks. It may employ technologies such as Wi-Fi, Bluetooth, cellular networking, Near Field Communication (NFC), or some combination thereof. The battery is the power source supplying energy to the wearable device's various components. It may be located within a separate compartment accessible through a battery access cover, ensuring safe handling of the electrical circuitry. The battery communicates with the processor and memory unit, allowing for real-time monitoring of the battery level and management of charging cycles. The enclosure is the outer case providing structural integrity, protection, and aesthetic design to the wearable device. It encapsulates all the internal components, ensuring their proper functioning while minimizing exposure to environmental hazards. The enclosure also typically includes apertures, openings, or grilles for audio, light emission, button access, and other critical interactions with the user. The microphone opening is a cutout in the enclosure specifically designed for the microphone to capture sound waves accurately while minimizing external noises that may interfere with voice recognition. The speaker grille may be a perforated pattern on the surface of the wearable device's housing, protecting the speaker from accidental damage or contamination while allowing sound to pass through unobstructed. The indicator light bulb may be a LED light in the device for better understanding of its location within the enclosure. It may be integrated into the front faceplate or somewhere easily visible to users. The privacy timer button is a button layout for operating the privacy timer feature, indicating the specific arrangement of buttons that correspond to setting different countdown durations before the device shuts down automatically. The battery access cover is a removable panel on the wearable device's body allowing access to the battery compartment for charging or replacement purposes. It may be attached using various mechanisms, such as snap-on connectors, screws, magnets, or other fasteners. The clip-on device refers to an attachment method, like a clip or strap, enabling users to securely mount the wearable device onto their clothing, bag, belt loop, etc., as needed.

In another aspect, an embodiment of the present disclosure provides a user interface data processing system for identifying deviations from planned activities at an industrial site, the user interface comprising one or more of the following: a graphical dashboard configured to receive and display analytics of the conversations and noisy environment; user input mechanisms configured to receive inputs from the user for managing functionalities of the data processing system; indicators configured to display a status of performance indicators of the audio recording device; customizable privacy settings. The user interface provides components that enable users to effectively monitor conversations, manage system functionalities, and customize privacy settings, contributing to the overall efficiency and accuracy of issue identification.

The graphical dashboard is configured to receive and display analytics of conversations and noisy environments in real-time or near real-time, providing users with valuable insights into potential issues at the industrial site. The visual representation of data can help users quickly identify trends or patterns that may indicate deviations from planned activities, enabling timely corrective actions.

The graphical dashboard may be a Web-based Dashboard. The web-based dashboard is provided for the project leader, allowing them to view AI-generated project reports, modify the quantity, duration, and frequency of privacy periods, geo-locate misplaced receiver units, and observe the battery charge of the receiver units. This enables project leaders to have real-time information about the system's performance and make necessary adjustments to ensure optimal operation. The web-based dashboard where the project leader can view AI project reports, modify the quantity, duration, and frequency of privacy periods, geo-locate misplaced receiver units, and observe the battery charge of receiver units.

User input mechanisms allow users to manage various functionalities of the data processing system, such as adjusting settings for audio recording devices, filtering conversations based on specific criteria, and initiating manual analysis or reporting functions. This gives users control over the system and ensures that they can effectively respond to potential issues in a timely and efficient manner.

Indicators display the status of performance indicators of the audio recording device, such as battery life, wireless connectivity strength, and microphone sensitivity. This information allows users to proactively address any issues with the devices, ensuring that they are functioning optimally and continuously capturing high-quality data for analysis.

Customizable privacy settings enable users to control how their data is collected, stored, and accessed, providing an added layer of security and compliance with relevant regulations and company policies. This can help build trust and confidence in the system among users, allowing for more effective adoption and utilization of its features.

The user interface data processing system improves efficiency and accuracy in identifying issues at industrial sites through analysis of conversation analytics, increased flexibility and control for users with customizable settings, and better transparency and accountability through clear visual representations of data and performance indicators. This enables more effective identification and resolution of potential issues at the industrial site, improved user experience and engagement with the system, and increased security and privacy compliance through customizable settings.

In another aspect, an embodiment of the present disclosure provides a computer program for identifying deviations from planned activities at an industrial site, the computer program comprising instructions which, when the program is executed by a data processing system, cause the data processing system to carry out the method according to the embodiments of the present disclosure. The computer program is designed to be executed by a data processing system, causing it to carry out one of the methods according to the embodiments of the present disclosure for analyzing recorded conversations and noisy environments to identify potential issues that may deviate from the project plan.

The use of a computer program provides several advantages and technical effects in addressing the technical problem of identifying issues at an industrial site which may deviate from the project plan. The computer program allows for automation of data processing and analysis, enabling faster identification of potential issues and reducing the reliance on manual monitoring and intervention. This can help to increase efficiency and accuracy, improve overall productivity and reduce errors in identifying and addressing issues at an industrial site. The computer program can be easily scaled up or down depending on the size and complexity of data being processed, making it suitable for various industrial applications with varying needs and requirements. The computer program can be customized to meet specific industry-specific requirements and data formats, allowing for more effective identification and resolution of issues unique to different types of industrial sites and processes. The computer program enables real-time or near real-time analysis of recorded conversations and noisy environments, allowing users to quickly identify and respond to potential issues as they occur, rather than waiting for manual review or batch processing. The computer program can be designed with robust data security measures and privacy controls to ensure that sensitive information is protected and accessible only to authorized personnel. This can help build trust and confidence in the system among users and stakeholders. The computer program can be integrated with other industrial systems, such as enterprise resource planning (ERP) or process control systems, enabling more comprehensive analysis of data and improved coordination between different teams and processes. The computer program can be updated regularly with new features, algorithms, and functionality to improve its effectiveness in identifying issues and providing value to industrial customers. This can help ensure that the system remains at the forefront of industry trends and requirements. The computer program can be accessed remotely through web-based or mobile applications, allowing users to monitor and analyze data from anywhere, at any time, using various devices and interfaces. This can help improve user convenience and flexibility in managing industrial operations and identifying issues as they occur.

In another aspect, an embodiment of the present disclosure provides a computer-readable storage medium comprising instructions for identifying deviations from planned activities at an industrial site, which, when executed by data processing system, cause the data processing system to carry out the method according to the embodiments of the present disclosure. The use of the computer-readable storage medium provides several advantages and technical effects in addressing the technical problem of identifying issues at an industrial site which may deviate from the project plan. The computer-readable storage medium provides a durable and reliable means for storing instructions, allowing them to be accessed and executed consistently over time. This can help ensure that the system remains functional and effective in identifying issues at an industrial site, even as hardware or software configurations change. The computer-readable storage medium allows for easy duplication and distribution of the instructions, enabling multiple data processing systems to execute the same method for analyzing recorded conversations and noisy environments. This can help improve overall system efficiency and scalability in addressing issues at large industrial sites or across multiple locations. The computer-readable storage medium can be updated with new versions of instructions, allowing for continuous improvement of the system and adaptation to changing requirements and industry trends. The computer-readable storage medium can be encrypted or otherwise protected against unauthorized access, helping ensure that sensitive information and intellectual property remain secure. The use of a computer-readable storage medium allows for cost savings by enabling the reuse of instructions across multiple data processing systems, rather than having to develop custom solutions for each individual system. The computer-readable storage medium can be designed with open standards or interfaces, allowing it to be easily integrated with other industrial systems and applications. This can help improve overall system functionality and interoperability, enabling more effective identification and resolution of issues at an industrial site. The computer-readable storage medium can be remotely installed on data processing systems, allowing for easy deployment and implementation of the system across multiple locations or in response to changing requirements. This can help improve user convenience and flexibility in managing industrial operations and identifying issues as they occur.

### DETAILED DESCRIPTION OF THE DRAWINGS

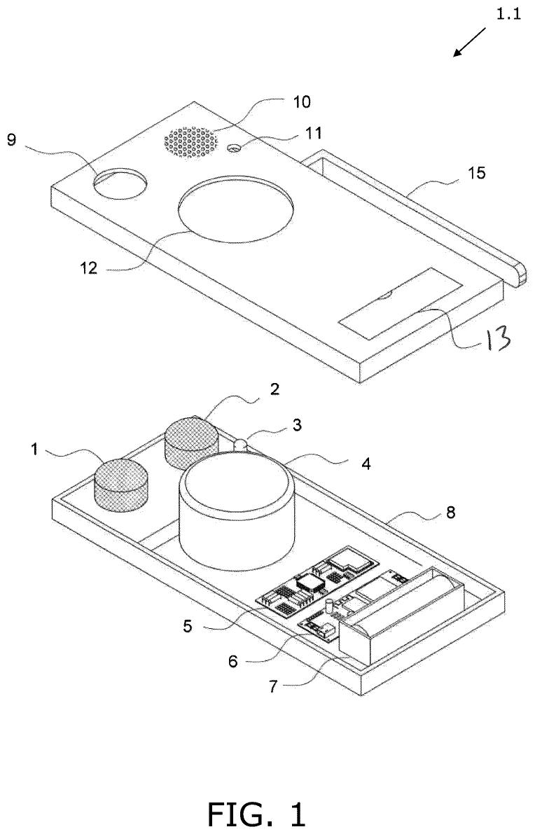

Referring to figure FIG. 1, there is shown a schematic view of the interior of the wearable device including the following components.

FIG. 1 illustrates a schematic view of a wearable device comprising a microphone 1, a speaker 2, an indicator light bulb 3, a privacy timer button pad 4, a processor and memory unit 5, a wireless connectivity module 6, a battery 7, and an enclosure 8. The wearable device also comprises a microphone opening 9, a speaker grill 10, an indicator light bulb 11, a privacy timer button 12, a battery access cover 13, and a clip on the device 14 for attaching the wearable device to clothing or other objects.

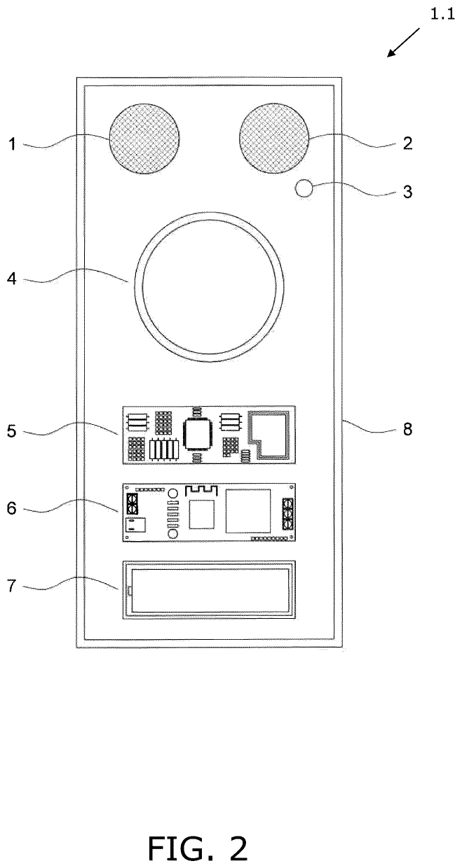

Referring to figure FIG. 2, there is shown an internal view of the wearable device comprising the microphone 1, the speaker 2, the indicator light bulb 3, the privacy timer button pad 4, the processor and memory unit 5, the wireless connectivity module 6, the battery 7, the enclosure 8.

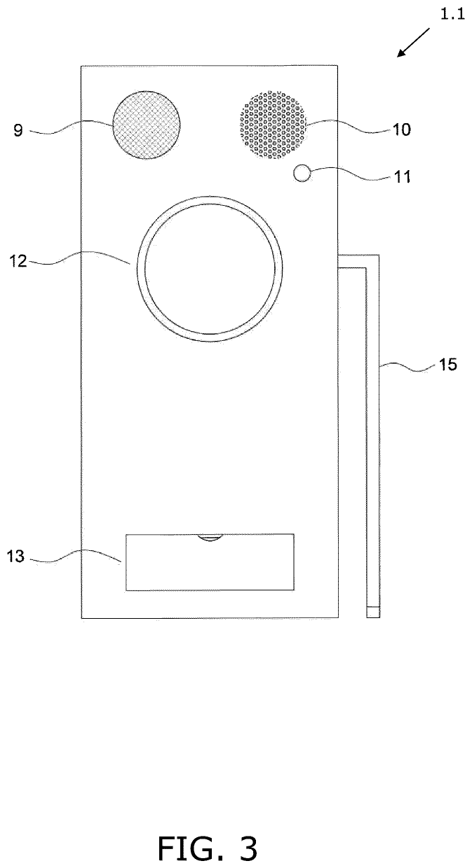

Referring to figure FIG. 3, there is shown an exterior view of the wearable device comprising the audio inlet grill 9, the speaker grill 10, the indicator light bulb cover 11, the privacy timer button 12, the battery access cover 13, the clip on device 14.

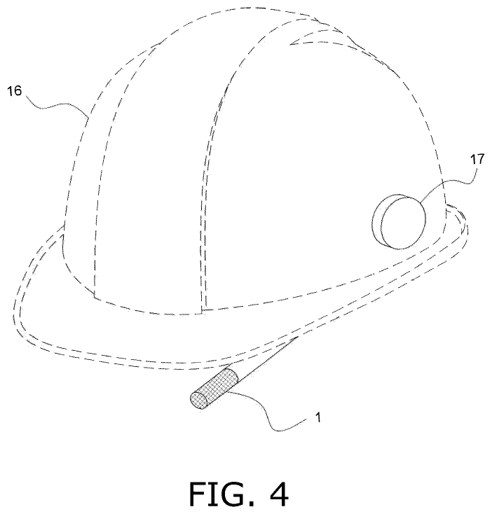

Referring to figure FIG. 4, there is shown an alternative embodiment of the wearable device, showing the microphone unit 1 integrated into a construction helmet 16 with privacy timer button 17.

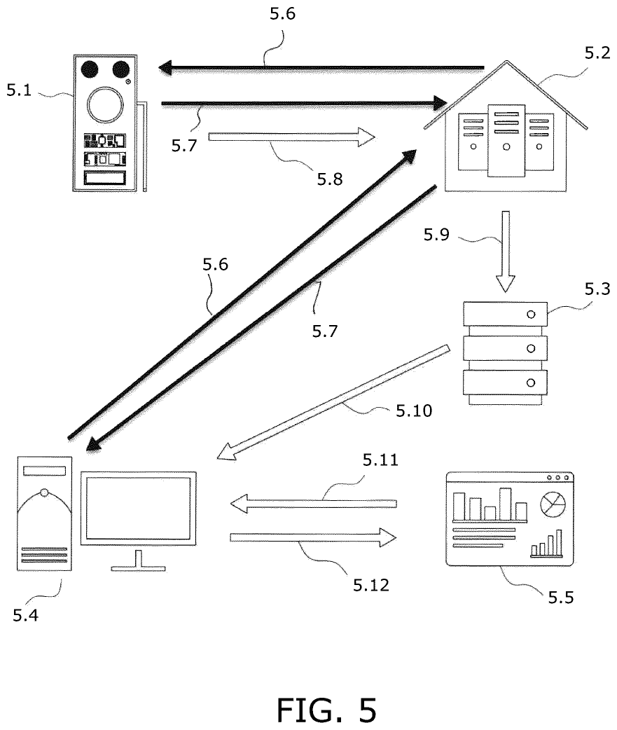

Referring to figure FIG. 5, a flowchart depicting the process of recording, transmitting, and analyzing construction site conversations using the wearable device 5.1, central hub 5.2, AI server 5.3, system server 5.4, and user web-based dashboard 5.5. At step 5.6. instruction data from system server 5.4 are sent to wearable device 5.1 through the central hub 5.2 (such as privacy period duration). At step 5.7. device status data from wearable device 5.2 is sent to system server 5.4 though central hub 5.2 (such as battery charge). At step 5.8. voice audio data is sent from wearable device 5.1 to central hub 5.2. At step 5.9. aggregated audio data from central hub 5.2 is sent to AI server 5.3. At step 5.10. AI analyzed data from AI server 5.3 is sent to system server 5.4. At step 5.11. AI analyzed data from central server 5.4 is sent to web-based dashboard 5.5. At step 5.12. user instruction data from web-based dashboard 5.5 is sent to system server 5.4.

1. A method for identifying deviations from planned activities at an industrial site, the method comprises:
obtaining a reference data of the industrial site;
predefining a time period for recording conversations occurring at the industrial site;
recording one or more conversations occurring during the predefined time period by one or more audio recording devices;
during the recording, implementing a privacy function upon detecting a privacy trigger;
performing an analysis of the recorded one or more conversations against the reference data;
identifying deviations from planned activities at the industrial site based on the analysed one or more conversations and the reference data.

2. The method according to claim 1, wherein obtaining the reference data comprises at least one of:
using a predefined template to generate the reference data;
obtaining the reference data through integration with one or more existing systems;
obtaining the reference data by leveraging machine learning algorithms;
using natural language processing techniques to analyze and extract relevant information from existing documents; or
utilizing computer vision techniques to capture and process visual data related to the industrial site.

3. The method according to claim 1, wherein predefining the time period for recording conversations occurring at the industrial site comprises at least one of:
using a schedule of planned activities;
using machine learning algorithms to predict and adjust the time period based on historical data;
setting different time periods for different areas of the industrial site; or
by integrating with existing scheduling or project management tools.

4. The method according to claim 1, wherein implementing the privacy function comprises at least one of:
using a manual on/off function in the audio recording device;
using an automatic on/off function;
providing a standalone device at private zones configured to switch off all audio recording devices in range;
automatically switching another audio recording device into privacy mode if nearby a first audio recording device is already in privacy mode;
using a user-controllable privacy timer functionality on the audio recording device to temporarily deactivate recording; or
limiting the number of privacy sessions per predefined period and/or restricting privacy sessions to specific times according to a schedule.

5. The method according to claim 1, wherein detecting the privacy trigger comprises at least one of:
using audio signal processing techniques to identify keywords indicating a requirement of privacy;
analyzing environmental factors;
identifying another audio recording device in privacy mode nearby;
integrating with other devices to gather additional data for detecting privacy triggers;
determining if the standalone device at the private zone is present and active;
detecting the scheduled time for restricted privacy sessions; or
receiving user input to initiate the detection of the privacy trigger.

6. The method according to claim 1, wherein preforming the analysis of the recorded one or more conversations against the reference data comprises one or more artificial intelligence techniques selected from a group comprising topic modeling, sentiment analysis, keyword extraction, trend analysis, anomaly detection, automated summarization, or action item identification.

7. The method according to claim 1, wherein the method further comprises identifying which recording belongs to which worker.

8. The method according to claim 1, wherein the method further comprises transferring the recorded conversations from the audio recording device
directly a server;
to a central hub located at the industrial site and then from the central hub to the server; or
downloading the recorded conversations to a temporary storage device and then uploading recorded conversations from the temporary storage device to a server.

9. The method according to claim 1, wherein the method further comprises timestamping the recorded conversations with a first time stamp indicating the start of each sub-session of the conversation and a second time stamp indicating the end of each sub-session of the conversations.

10. The method according to claim 1, wherein the method further comprises creating a data layer per the predefined time period comprising a data component and a time component.

11. An audio recording device for use in a method according to claim 1, wherein the audio recording device comprises
a microphone array;
a processor and memory module configured to
control an operation of the audio recording device,
run one or more software modules,
buffer audio, and
manage wireless communication;
a wireless connectivity module;
a privacy timer activation means; and
a battery.

12. A data processing system for identifying deviations from planned activities at an industrial site,
the system comprises:
one or more servers comprising an audio data processing unit, wherein the one or more servers are integrable with a management software platform;
one or more audio recording devices wirelessly connected to the audio data processing unit;
one or more user devices configured to run a user interface.

13. A user interface data processing system for identifying deviations from planned activities at an industrial site,
the user interface comprising one or more of the following:
a graphical dashboard configured to receive and display analytics of the conversations and noisy environment;
user input mechanisms configured to receive inputs from the user for managing functionalities of the data processing system;
indicators configured to display a status of performance indicators of the audio recording device;
customizable privacy settings.

14. A computer program for identifying deviations from planned activities at an industrial site, the computer program comprising instructions which, when the program is executed by a data processing system, cause the data processing system to carry out the method of claim 1.

15. A computer-readable storage medium comprising instructions for identifying deviations from planned activities at an industrial site, which, when executed by data processing system, cause the data processing system to carry out the method of claim 1.
